(19) United States
(12) Patent Application Publication
(10) Pub. No.: US 2025/0107492 A1
(43) Pub. Date: Apr. 3, 2025

(54) VERTICAL GROWING STRUCTURE INSERT

(71) Applicant: 0865894 B.C. LTD.O/A AGREITECH NORTH, Dryden (CA)

(72) Inventors: Benjamin FEAGIN JR., Dryden (CA); Samantha Charlene ALLAN, Dryden (CA); Fabian Prince VELEZ, Dryden (CA); Nicholas WOOLF, London (CA)

(21) Appl. No.: 18/476,523

(22) Filed: Sep. 28, 2023

(51) Int. Cl. A01G 9/02

(52) U.S. Cl. CPC A01G 9/022

(57) ABSTRACT

A system for growing a plant includes a vertical growing structure having a plurality of interconnected walls, the walls partially enclosing a cavity. An aperture is disposed through one of the plurality of interconnected walls. A growing media is disposed in the cavity. Roots of the plant are growable into the growing media. An insert is received through the aperture. The insert includes a supporting member protruding from the aperture. A first wing extends transversely from the supporting member. A second wing extends transversely from the supporting member opposite the first wing. The first wing and the second wing are trapped between the growing media and the one of the plurality of interconnected walls to retain the insert in the aperture. The supporting member supports stems of the plant and diverts water from the plant towards the cavity.

### TECHNICAL FIELD

This disclosure generally relates to the field of vertical growing structures.

### BACKGROUND

Vertical growing structures, for instance vertical growing towers, are elongated structures for supporting and promoting the growth of plants. Such towers are typically filled with growing media that is responsible for providing a substrate into which the roots of the plants can grow, and which is also used to convey the water and nutriments to the plants. However, as the roots of the plants grow upwardly, water may tend to run along the roots and drip out of the growing structure from the stem of the plants, which may lead to a lack of water in the growing structure.

### SUMMARY

In accordance with one aspect, there is provided a system for growing a plant, comprising: a vertical growing structure having a plurality of interconnected walls, the walls partially enclosing a cavity, an aperture disposed through one of the plurality of interconnected walls, a growing media disposed in the cavity, wherein roots of the plant are growable into the growing media; and an insert received through the aperture, the insert including a supporting member protruding from the aperture, a first wing extending transversely from the supporting member, a second wing extending transversely from the supporting member opposite the first wing, the first wing and the second wing trapped between the growing media and the one of the plurality of interconnected walls for retaining the insert in the aperture, the supporting member supporting stems of the plant and diverting water from the plant towards the cavity.

In another aspect, there is provided an insert for a vertical plant growing structure, the insert receivable through an aperture in a wall of the vertical plant growing structure, the insert comprising: a supporting member configured for protruding from the aperture in the wall and supporting stems of a plant growing in a growing media in the vertical plant growing structure; a first wing extending transversely from the supporting member; and a second wing extending transversely from the supporting member opposite the first wing; wherein the first wing and the second wing are configured for being trapped between the growing media and the wall for retaining the insert in the aperture.

In a further aspect, there is provided a method for supporting a plant growing in a growing media in a cavity of a vertical growing structure, comprising: inserting an insert into an aperture through a wall of the vertical growing structure, the insert retained in the aperture by the growing media, a supporting member of the insert protruding from the aperture; and supporting, via the supporting member of the insert, stems of the plant, the supporting member configured for diverting water from the plant towards the cavity.

Many further features and combinations thereof concerning the present improvements will appear to those skilled in the art following a reading of the instant disclosure.

### BRIEF DESCRIPTION OF THE DRAWINGS

FIG. 1A is a perspective view of a system for growing a plant, in accordance with an embodiment;

FIG. 1B is an exploded perspective view of the system of FIG. 1A;

FIG. 1C is a lower perspective view of the system of FIG. 1A;

FIG. 2 is a perspective view of a vertical growing structure and growing media for the system of FIGS. 1A-1C;

FIG. 3 is a perspective view of an insert for the system of FIGS. 1A-1C;

FIG. 4 is a perspective view of an additional insert for the system of FIGS. 1A-1C;

FIG. 5 is a perspective view of a cover plate for the system of FIGS. 1A-1C; and

FIG. 6 is a perspective view of a bottom insert for the system of FIGS. 1A-1C.

### DETAILED DESCRIPTION

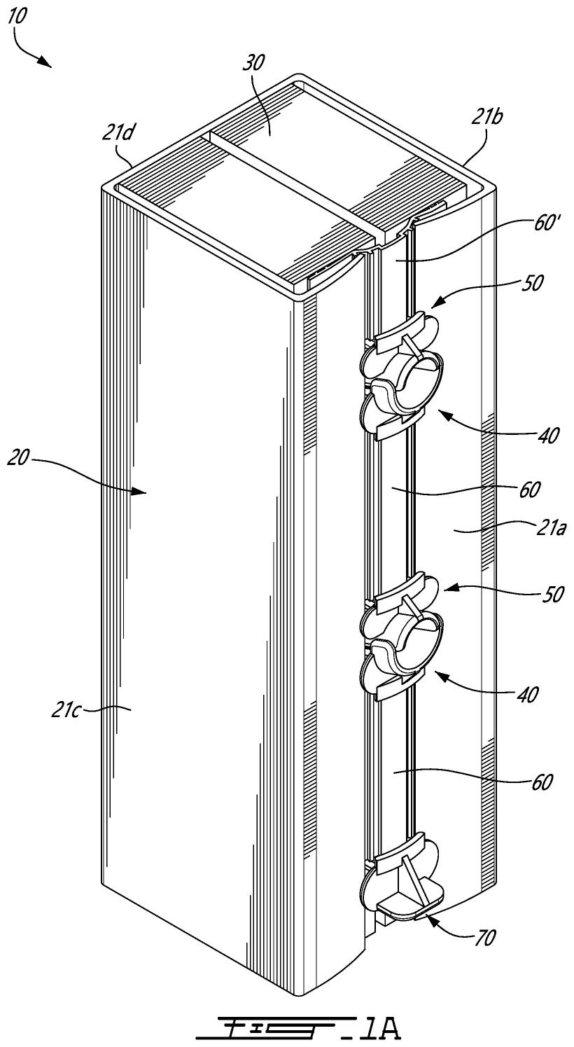

FIGS. 1A-1C show an example of a system 10 for growing one or more plants including a vertical growing structure 20, a growing media 30 (omitted from FIG. 1C) disposed within the vertical growing structure in which roots of the plant are growable, and various insertable components 40, 50, 60, 70 insertable into the vertical growing structure. Various plants may be grown via the system 10, such as leafy greens, herbs, fruity crops, flowers and cannabis. Other plants may be contemplated as well.

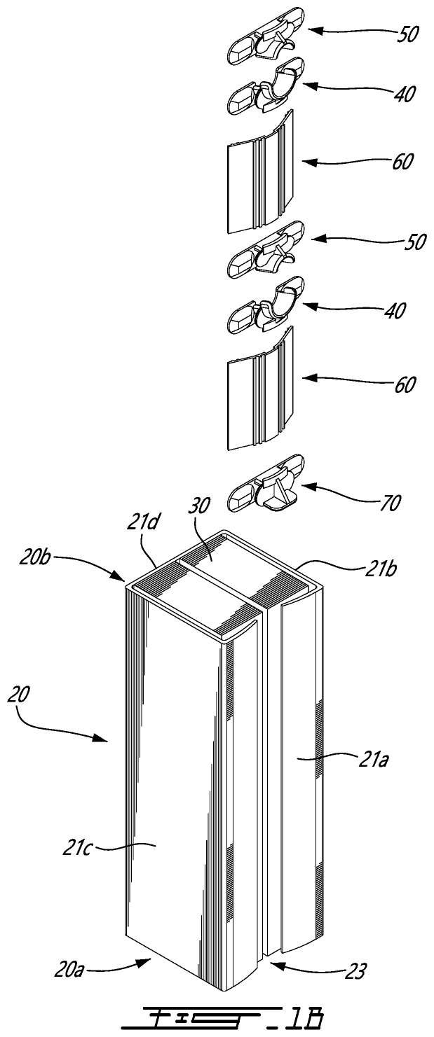

In the shown case, the vertical growing structure 20 is a vertical growing tower, although other vertically-oriented growing structures, such as facias or modules, may be contemplated. The depicted vertical growing structure 20, shown in more detail in FIG. 2, includes a plurality of interconnected walls 21, illustratively a front wall 21a, side walls 21b, 21c and a rear wall 21d. The walls 21 extend from a bottom end 20a of the vertical growing structure 20 to a top end 20b of the vertical growing structure 20, and enclose a cavity 22. An aperture 23 is disposed through one of walls 21, illustratively the front wall 21a. In the shown case, the aperture 23 is a vertical slit 23 having a width W extending along a vertical length of the front wall 21a (i.e., from the bottom end 20a to the top end 20b), or of another wall 21. In other cases, the vertical slit 23 may only partially extend along the vertical length of one of the walls 21. In other cases, a plurality of holes or perforations may be disposed through a wall 21, for instance arranged vertically from the bottom end 20a to the top end 20b. Other apertures 23 may be contemplated.

As discussed above, a growing media 30, in which roots of the plant are growable, is disposed in the cavity 22. In addition, the growing media 30 may be configured for carrying water and nutriments throughout the cavity 22. Various growing media 30 may be contemplated, such as peat moss or foam. In the shown case, the growing media 30 includes two growing media 30 arranged side-by-side in the cavity 22. Each depicted growing media 30 extends vertically from the bottom end 20a to the top end 20b and engages the front wall 21a, the rear wall 21d and one of the side walls 21b, 21c, with a gap G disposed between the two growing media 30 (see FIG. 2). In some cases, a wicking strip (not shown) may be inserted into the gap G, which may thus be sized accordingly. Other numbers and sizes of growing media may be contemplated, such as one or more growing media 30 partially or fully occupying the internal volume of the cavity 22.

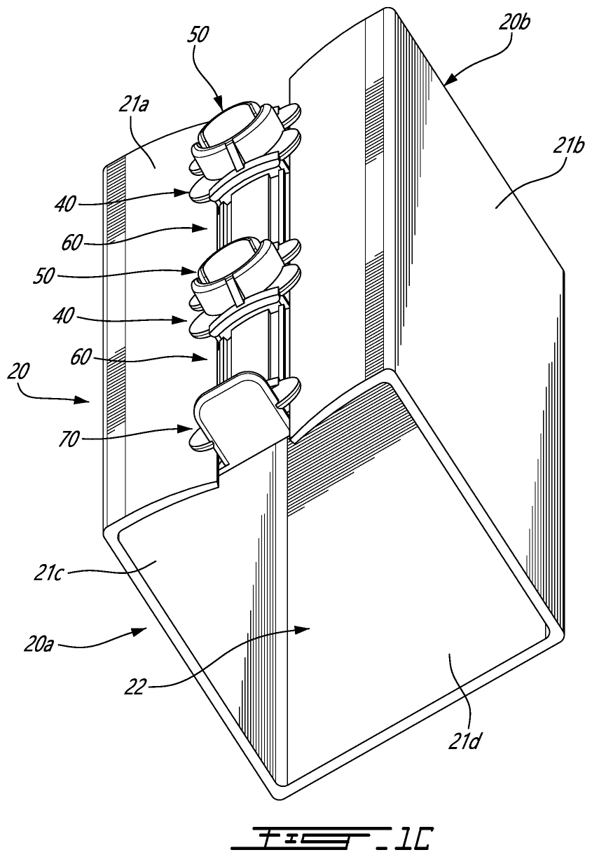

Referring additionally to FIG. 3, the system 10 includes one or more inserts 40 (two inserts 40 shown in FIGS. 1A-1C) for supporting the plant(s), for instance the roots of the plant(s). Each insert 40 is received through the aperture 23 (e.g., the vertical slit 23) and includes a supporting member 41 for supporting the root of the plant (or other portion of the plant(s)) from a bottom thereof, and wings 42, illustratively two wings 42, for retaining the insert 40 in the aperture 23.

The supporting member 41 illustratively protrudes from the aperture 23 and is operable to support roots or stems of the plant, and divert water from the plant towards the cavity 22. In the shown embodiment, but not necessarily the case in all embodiments, the supporting member 41 slopes upwardly as it protrudes outwardly from the aperture 23. This upward slope may, for instance, assist in diverting water towards the cavity 22 and to counter plant sagging. The angle of the upward slope may vary. In the shown case, the supporting member 41 includes a base portion 41a disposed between the wings 42 and an upper portion 41b, disposed above the base portion 41a, and on which the plant roots or stems are supported. In the shown case, the upper portion 41b has a semi-circular cross section, although other shapes may be contemplated. The depicted supporting member 41 further includes a bottom portion 41c disposed below the base portion 41a. The bottom portion 41c is configured for engaging with other insertable components of the system 10, as will be discussed in further detail below. The dimensions of the base portion 41a may vary, for instance based on the size of the aperture 23 to ensure proper insertion and retention thereinto.

As discussed above, the depicted insert 40 includes two wings 42, each wing 42 extending transversely opposite the other wing 42. Once the insert 40 is inserted, the wings 42 are configured for retaining the insert 40 in the aperture 23 by being trapped between the growing media 30 and a wall 21, illustratively the front wall 21a. Other numbers and orientations of wings 42 may be contemplated. In the shown embodiment, the wings 42 include a raised or ribbed portion 42a to assist with engagement with the wall 21 and/or the growing media 30, and to assist with water management. In some cases, the insert 40 may be inserted into the aperture 23 with the wings 42 oriented vertically. Once inserted, the insert 40 may then be rotated, for instance by 90 degrees, so that the wings 42 are oriented horizontally and are engageable with the growing media 30 and front wall 21a. Other insertion means may be contemplated, for instance by sliding one wing 42 into the aperture 23 before sliding in the other wing 42.

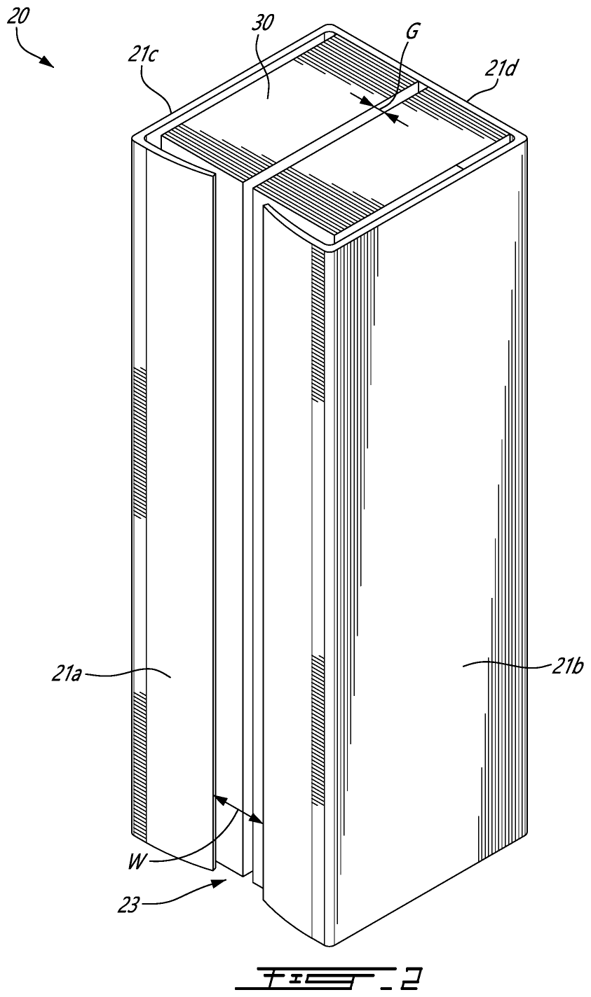

Referring additionally to FIG. 4, in some cases the system 10 may be provided with one or more optional additional inserts 50 (two additional inserts 50 shown in FIGS. 1A-1C). The additional inserts 50 are received through the aperture 23 (e.g., the vertical slit 23) and may be complementary to corresponding inserts 40. Stated differently, each additional insert 50 may be disposed above a corresponding insert 40 in the aperture 23 to assist with supporting a portion of a plant. Each additional insert 50 illustratively includes a supporting member 51 for supporting the root of the plant (or other portion of the plant(s)) from a top thereof. and wings 52, illustratively two wings 52, for retaining the insert 50 in the aperture 23.

The supporting member 51 illustratively protrudes from the aperture 23 and is operable to support roots or stems of the plant, and divert water from the plant towards the cavity 22. In the shown embodiment, but not necessarily the case in all embodiments, the supporting member 51 slopes upwardly as it protrudes outwardly from the aperture 23. This upward slope may, for instance, assist in diverting water towards the cavity 22. The angle of the upward slope may vary. In the shown case, the supporting member 51 includes a base portion 51a disposed between the wings 52 and a lower portion 51b, disposed below the base portion 51a, and assists in supporting the plant roots or stems. In the shown case, the lower portion 51b has a semi-circular cross section, although other shapes may be contemplated. The shape of the supporting member 51 may mirror that of the supporting member 41. The depicted supporting member 51 further includes an upper portion 51c disposed above the base portion 51a. The upper portion 51c is configured for engaging with other insertable components of the system 10, as will be discussed in further detail below.

As discussed above, the depicted additional insert 50 includes two wings 52, each wing 52 extending transversely opposite the other wing 52. Once the additional insert 50 is inserted, the wings 52 are configured for retaining the insert 50 in the aperture 23 by being trapped between the growing media 30 and a wall 21, illustratively the front wall 21a. Other numbers and orientations of wings 52 may be contemplated. In the shown embodiment, the wings 52 include a raised or ribbed portion 52a to assist with engagement with the wall 21 and/or the growing media 30, and to assist with water management. In some cases, the insert 50 may be inserted into the aperture 23 with the wings 52 oriented vertically. Once inserted, the insert 50 may then be rotated, for instance by 90 degrees, so that the wings 52 are oriented horizontally and are engageable with the growing media 30 and front wall 21a. Other insertion means may be contemplated. In some cases, each additional insert 50 is disposed immediately above a corresponding insert 40 (i.e., with the supporting members 41, 51 abutting one another). In other cases, for instance where the roots of the plant occupy more space, each additional insert 50 may be vertically spaced apart from a corresponding insert 40. Other arrangements, for example combinations of the above, may be contemplated.

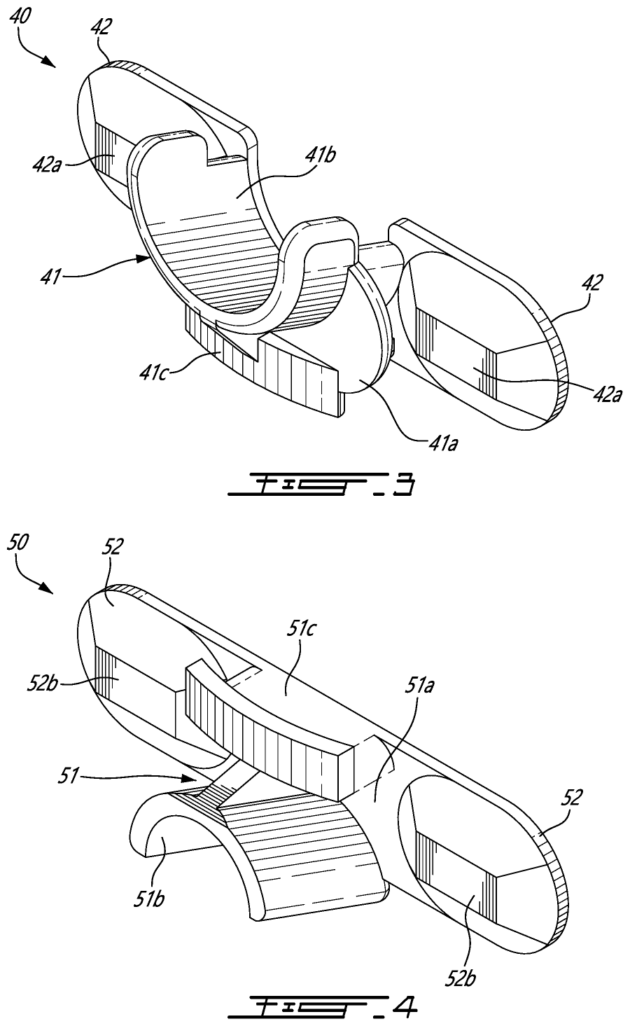

Referring additionally to FIG. 5, the system 10 may be provided with one or more optional cover plates 60 (illustratively two cover plates 60 and an additional cover plate 60′) to at least partially cover (i.e., block light from entering) the vertical slit 23 along its length. The cover plates may also provide stability to the vertical growing structure 20. Each depicted cover plate 60 includes a front side 60a (facing away from the cavity 22) and a rear side 60b (facing towards the cavity 22), and further includes a covering portion 61 and two side portions 62. The covering portion 61 may be sized to correspond with the width W of the vertical slit 23 so that light is prevented from entering the cavity 22 via the vertical slit 23, while the side portions 62 extend transversely from the covering portion 61 and are configured for retaining the cover 60 in the vertical slit 23. For instance, the side portions 62 may become trapped between the growing media 30 and the front wall 21a. In some cases, the side portions 62 may be bendable or foldable relative to the covering portion 61 to assist with the insertion of the cover 60 within the vertical slit 23. In addition, protrusions or ribs 63a, 63b may be disposed on the front side 60a and/or the rear side 60b to assist with engagement with the front wall 21a and/or the growing media 30.

The number and size of cover plates 60 may vary. In the shown case, two cover plates 60 are provided to occupy the empty space in the aperture 23 between other insertable components. The number and/or size of the cover plates 60 may thus vary, for instance to accommodate varying sized vertical growing structures 20 or different numbers and/or sizes of other insertable components. In addition, the bottom portions 41c of the inserts 40 and the upper portions 51c of the additional inserts 50 may be configured for engaging with the cover plate 60 so that the various components in the vertical slit 23 support one another in a vertical direction. The additional cover plate 60′, also referred to as the uppermost cover plate 60′, may be dimensioned to occupy the space in the slit 60 between the uppermost insert 40 (or additional insert 50, as shown in FIG. 1), and the top end 20b to prevent light from entering through the slit 60 at this location. The uppermost cover plate 60′, along with the top end 20b, may form a closed or continuous upper permitter for the vertical growing structure 20. In the shown case, the uppermost cover plate 60′ is shorter in length than the cover plates 60, and otherwise has the same general structure and shape. In some cases, based on the overall length of the vertical growing structure 20, one of the cover plates 60 may be used as the uppermost cover plate 60′).

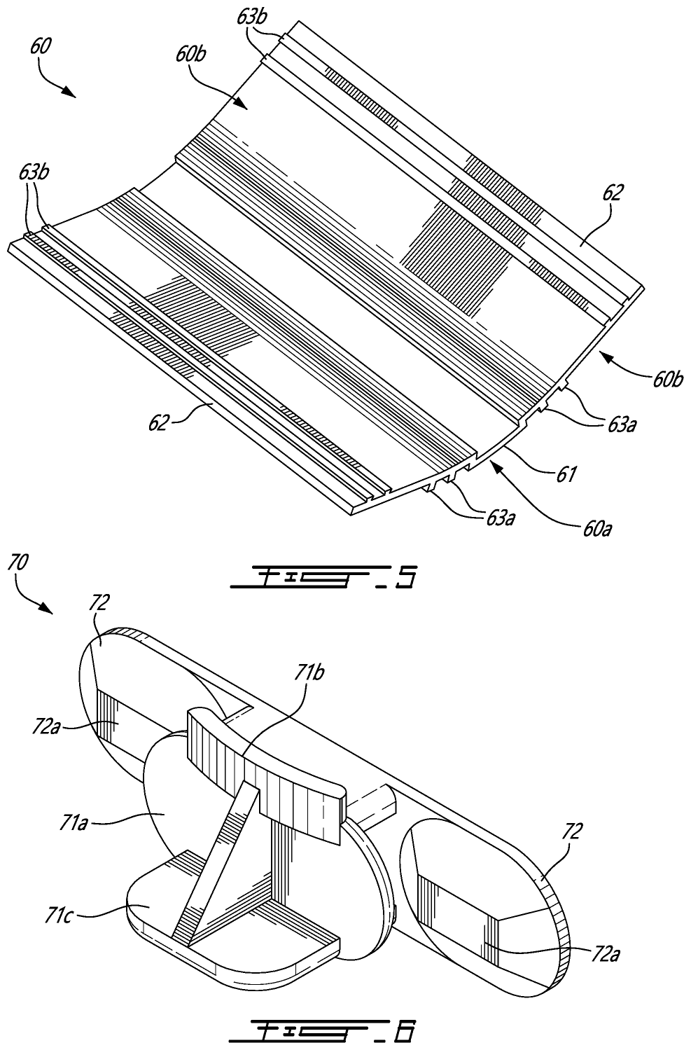

Referring additionally to FIG. 6, the system 10 may include a bottom insert 70 received through the vertical slit 23 and disposed below a lower-most of the other insertable components, illustratively a lowermost of the cover plates 60. The bottom insert 70 is configured to be the lower-most insertable component of the system 10 and thus provide support to the other insertable components. The depicted bottom insert 70 includes a base portion 71a, an upper portion 71b engageable with the component disposed above the bottom insert 70 (illustratively a cover plate 60), a planar bottom portion 71c for optionally engaging with the ground for support, and wings 71, illustratively two wings 71, for retaining the bottom insert 70 in the aperture 23. In the shown case, the bottom insert 70 is vertically spaced from the bottom end 20a of the vertical growing structure 20, for instance to accommodate for the vertical growing tower 20 sitting in a trough. Other arrangements may be contemplated, such as the bottom insert 70 being disposed immediately at the bottom end 20a, or a cover plate 60 being disposed between the bottom insert 70 and the bottom end 20a.

As discussed above, the depicted bottom insert 70 includes two wings 72, each wing 72 extending transversely opposite the other wing 72. Once the bottom insert 70 is inserted, the wings 72 are configured for retaining the bottom insert 70 in the aperture 23 by being trapped between the growing media 30 and a wall 21, illustratively the front wall 21a. Other numbers and orientations of wings 72 may be contemplated. In the shown embodiment, the wings 72 include a raised or ribbed portion 72a to assist with engagement with the wall 21 and/or the growing media 30. In some cases, the bottom insert 70 may be inserted into the aperture 23 with the wings 72 oriented vertically. Once inserted, the insert 70 may then be rotated, for instance by 90 degrees, so that the wings 72 are oriented horizontally and are engageable with the growing media 30 and front wall 21a. Other insertion means may be contemplated.

In accordance with this disclosure, an exemplary method for supporting a plant growing in a growing media 30 in a cavity 22 of a vertical growing structure 20 is disclosed. An insert 40 is inserted into an aperture 23 through a wall 21 of the vertical growing structure 20, the insert 40 retained in the aperture 23 by the growing media 30, a supporting member 41 of the insert 40 protruding from the aperture 23. The supporting member 41 of the insert 40 supports stems of the plant, the supporting member 41 configured for diverting water from the plant towards the cavity 22.

In an embodiment, inserting the insert 40 further includes inserting the insert 40 through the aperture 23 with wings 42 of the insert 40 disposed in a vertical orientation, and subsequently rotating the insert 40 such that the wings 42 are disposed in a horizontal orientation, the wings 42 confined between the wall 21 of the vertical growing structure 20 and the growing media 30.

In an embodiment, the aperture 23 is a vertical slit 23 extending along a vertical length of the wall 21, and inserting the insert 40 further includes inserting a plurality of the insert 40 through the vertical slit 23.

In an embodiment, one or more additional inserts 50 are inserted above each of the plurality of the insert 40 to vertically surround the stems of the plant.

In an embodiment, a plurality of cover plates 60 are inserted into in the vertical slit 23 between adjacent ones of the plurality of the insert 40 to substantially cover the vertical slit 23.

As discussed above, while the depicted vertical growing structure 20 includes a vertical slit 23, other apertures 23 may be contemplated. For instance, one or more holes or perforations may be arranged along one of the walls 21, for instance a plurality of vertically arranged holes or perforations, with each hole or perforation receiving an insert 40 and optionally an additional insert 50. The shape of such holes or perforations may vary, for instance in order to accommodate the various inserts 40, 50. In such cases, the cover plates 60 may be omitted, as light may be prevented from entering the cavity 22 due to the absence of openings beyond the holes occupied by inserts 40. Other apertures 23 may be contemplated.

Advantageously, the various insertable components (illustratively the inserts 40, additional inserts 50, cover plates 60 and bottom insert 70) may divert water back into the cavity 22 and substantially block or conceal the vertical slit 23, i.e., prevent light from entering cavity 22 via the opening 23. This may, for instance, abate algae and other growth inside the cavity 22, thereby preventing rot. Leaks may also be mitigated due to the insertable components.

As can be seen therefore, the examples described above and illustrated are intended to be exemplary only. The scope is indicated by the appended claims.

1. A system for growing a plant, comprising:
a vertical growing structure having a plurality of interconnected walls, the walls partially enclosing a cavity, an aperture disposed through one of the plurality of interconnected walls, a growing media disposed in the cavity, wherein roots of the plant are growable into the growing media; and
an insert received through the aperture, the insert including a supporting member protruding from the aperture, a first wing extending transversely from the supporting member, a second wing extending transversely from the supporting member opposite the first wing, the first wing and the second wing trapped between the growing media and the one of the plurality of interconnected walls for retaining the insert in the aperture, the supporting member supporting stems of the plant and diverting water from the plant towards the cavity.

2. The system as defined in claim 1, further comprising an additional insert received in the aperture above the insert.

3. The system as defined in claim 2, wherein the insert and the additional insert are vertically spaced apart from one another, the insert and the additional insert vertically surrounding the stems of the plant.

4. The system as defined in claim 2, wherein the insert and the additional insert are vertically disposed against one another.

5. The system as defined in claim 1, wherein the aperture is a vertical slit extending along a vertical length of the one of the plurality of walls.

6. The system as defined in claim 5, further comprising a cover plate disposed in the vertical slit, above or below the insert, the cover plate including a covering portion, a first side portion extending transversely from the covering portion, and a second side portion extending transversely from the covering portion, the first side portion and the second side portion retaining the cover plate in the vertical slit, the covering portion at least partially covering the vertical slit.

7. The system as defined in claim 6, wherein the cover plate is disposed below the insert, and the insert includes a bottom portion configured for engaging with the cover plate.

8. The system as defined in claim 6, further comprising a plurality of the insert and a plurality of the cover plate, wherein the plurality of the cover plate substantially cover the vertical slit along the vertical length of the one of the plurality of walls.

9. The system as defined in claim 8, further comprising a bottom insert received through the vertical slit below a lower-most of the plurality of the cover plate, the bottom insert having a planar bottom.

10. The system as defined in claim 1, wherein the supporting member slopes upwardly protruding from the aperture.

11. The system as defined in claim 1, wherein the supporting member has a base portion disposed between the first wing and the second wing, and an upper portion having a semi-circular cross section.

12. The system as defined in claim 1, wherein the first wing and the second wing are each ribbed for engagement with the growing media.

13. An insert for a vertical plant growing structure, the insert receivable through an aperture in a wall of the vertical plant growing structure, the insert comprising:
a supporting member configured for protruding from the aperture in the wall and supporting stems of a plant growing in a growing media in the vertical plant growing structure;
a first wing extending transversely from the supporting member; and
a second wing extending transversely from the supporting member opposite the first wing;
wherein the first wing and the second wing are configured for being trapped between the growing media and the wall for retaining the insert in the aperture.

14. The insert as defined in claim 13, wherein the supporting member has a base portion disposed between the first wing and the second wing, and an upper portion having a semi-circular cross section.

15. The insert as defined in claim 13, wherein the first wing and the second wing are each ribbed for engagement with the growing media.

16. A method for supporting a plant growing in a growing media in a cavity of a vertical growing structure, comprising:
inserting an insert into an aperture through a wall of the vertical growing structure, the insert retained in the aperture by the growing media, a supporting member of the insert protruding from the aperture; and
supporting, via the supporting member of the insert, stems of the plant, the supporting member configured for diverting water from the plant towards the cavity.

17. The method as defined in claim 16, wherein the inserting the insert further includes inserting the insert through the aperture with wings of the insert disposed in a vertical orientation, and subsequently rotating the insert such that the wings are disposed in a horizontal orientation, the wings confined between the wall of the vertical growing structure and the growing media.

18. The method as defined in claim 16, wherein the aperture is a vertical slit extending along a vertical length of the wall, and wherein inserting the insert further includes inserting a plurality of the insert through the vertical slit.

19. The method as defined in claim 18, further comprising inserting one or more additional inserts above each of the plurality of the insert to vertically surround the stems of the plant.

20. The method as defined in claim 18, further comprising inserting a plurality of cover plates in the vertical slit between adjacent ones of the plurality of the insert to substantially cover the vertical slit.
